(19) United States
(12) Patent Application Publication
(10) Pub. No.: US 2007/0222282 A1
(43) Pub. Date: Sep. 27, 2007

(54) Motorcycle brake connector

(76) Inventors: Kenneth R. Thurm, Orange, CA (US); Scott Longnecker, Buena Park, CA (US)

Correspondence Address: STETINA BRUNDA GARRED & BRUCKER, 75 ENTERPRISE, SUITE 250, ALISO VIEJO, CA, 92656, US

(21) Appl. No.: 11/389,915

(22) Filed: Mar. 27, 2006

(51) Int. Cl. B60T 13/00

(52) U.S. Cl. 303/9.64

(57) ABSTRACT

A brake connector having a pressure sensor attached thereto is protected from an environment. In particular, the brake connector may be attachable to a transmission case of the motorcycle. The pressure sensor may be disposed between the engine and the transmission case or behind the transmission case when the brake connector is attached to the transmission case such that the engine and/or transmission case protects the pressure sensor from projectiles such as road debris. A protective cover may also cover the pressure sensor to protect the pressure sensor from road debris and the like.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a device for protecting a pressure sensor of a brake system.

A braking system of a Harley Davidson motorcycle may comprise a brake pedal, master cylinder, and a brake fluid line which leads from the master cylinder to a rear brake caliper. To operate the rear caliper, the user may depress the brake pedal to transfer fluid from the master cylinder through the brake line to the rear caliper to activate a rear brake. To release the rear brake, the user may release the brake pedal to transfer fluid back into the master cylinder from the rear caliper.

The braking system may also comprise a pressure sensor which transmits an electrical signal to an electrical system of the Harley Davidson motorcycle when the brake pedal is depressed. The pressure sensor is attached to the brake fluid line in a manner such that the pressure sensor may measure the pressure within the brake line. When the brake pedal is depressed, fluid is transferred into the brake line and increases the pressure in the brake fluid line. When the pressure in the brake line exceeds a threshold pressure, the pressure sensor senses such condition and sends an electrical signal to the electrical system indicating that the brake pedal is being depressed. The electrical system then activates a rear brake light to indicate to other drivers, pedestrians and motorcyclists that the Harley Davidson motorcycle is slowing down or will stop.

Conventionally, the pressure sensor is not attached or secured to a frame of the motorcycle but is dangling in mid-air. One problem associated with the current configuration of the pressure sensor is that the pressure sensor may continuously hit other nearby objects thereby damaging the pressure sensor. For example, as the motorcycle rider rides the motorcycle, road debris may hit the pressure sensor thereby damaging the pressure sensor. Moreover, the rider of the Harley Davidson motorcycle may accidentally damage the pressure sensor as the rider mounts and de-mounts the motorcycle because the rider's foot may become tangled with the brake fluid line. Accidentally, the rider's foot may apply excessive force on the brake line thereby pulling the brake line off of the rear caliper or the master cylinder. In one instance, the above mentioned deficiencies with the prior art pressure sensor required a Harley Davidson motorcycle owner to replace the motorcycle's pressure sensor twice offer a period of 67,000 miles.

Accordingly, there is a need in the art for a device for protecting the pressure sensor, and more preferably, a device for protecting the pressure sensor in an aesthetically pleasing manner.

### BRIEF SUMMARY

A brake connector is disclosed herein which addresses the needs discussed above, below and those that are known in the art.

The brake connector may have a main body which has an inlet aperture, outlet aperture and a pressure sensor aperture. The inlet aperture is connected to an inlet fluid cable. The outlet aperture is connected to an outlet fluid cable. The pressure sensor aperture is connected to a pressure sensor. The inlet aperture, outlet aperture and pressure sensor aperture are fluidically interconnected via a fluid conduit. The brake connector is attachable to a transmission case of a motorcycle. For example, the brake connector may be attached to the transmission case of a Harley Davidson motorcycle. It is also contemplated that the brake connector may be attached to other types of vehicles such as ATV, different motorcycle brands, automobiles, etc.

The brake connector may have one but preferably at least two bolt holes through which bolts may secure the brake connector to the existing bolt holes of the motorcycle's transmission case. This secures the brake connector as well as the pressure sensor to the motorcycle. When the brake connector is secured to the transmission case, the pressure sensor is disposed behind the transmission case or interposed between the transmission case and the engine. The transmission case and/or the engine protect the pressure sensor from debris and the like from damaging the pressure sensor. Also, a cover is disposed over the pressure sensor and secured to the main body of the brake connector. The cover provides additional protection against damage to the pressure sensor from road debris and projectiles.

The brake connector also follows the general motif of the Harley Davidson motorcycle. For example, as discussed herein, the brake connector may be attached to the transmission case. The brake connector may have an outer peripheral surface having a configuration that blends with the transmission case. Moreover, the brake connector may be chromed to further follow the general motif of the Harley Davidson's transmission case.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front elevational view of a Harley Davidson motorcycle having a left side drive;

FIG. 2 is an enlarged front elevational view of a transmission case of the motorcycle shown in FIG. 1 with a brake connector attached thereto;

FIG. 3 is a rear elevational view of the brake connector shown in FIG. 2;

FIG. 4 is a schematic of hydraulic and electric systems of the Harley Davidson motorcycle;

FIG. 5 is a top view of FIG. 2 showing the transmission case protecting the pressure sensor from road debris and the like, etc.;

FIG. 6 is an exploded bottom view of FIG. 2 illustrating a protective cap over a pressure sensor for protecting the pressure sensor;

FIG. 7 is an enlarged front elevational view of a transmission case for a right side drive Harley Davidson motorcycle with a brake connector attached thereto; and

FIG. 8 is a top view of FIG. 7.

### DETAILED DESCRIPTION

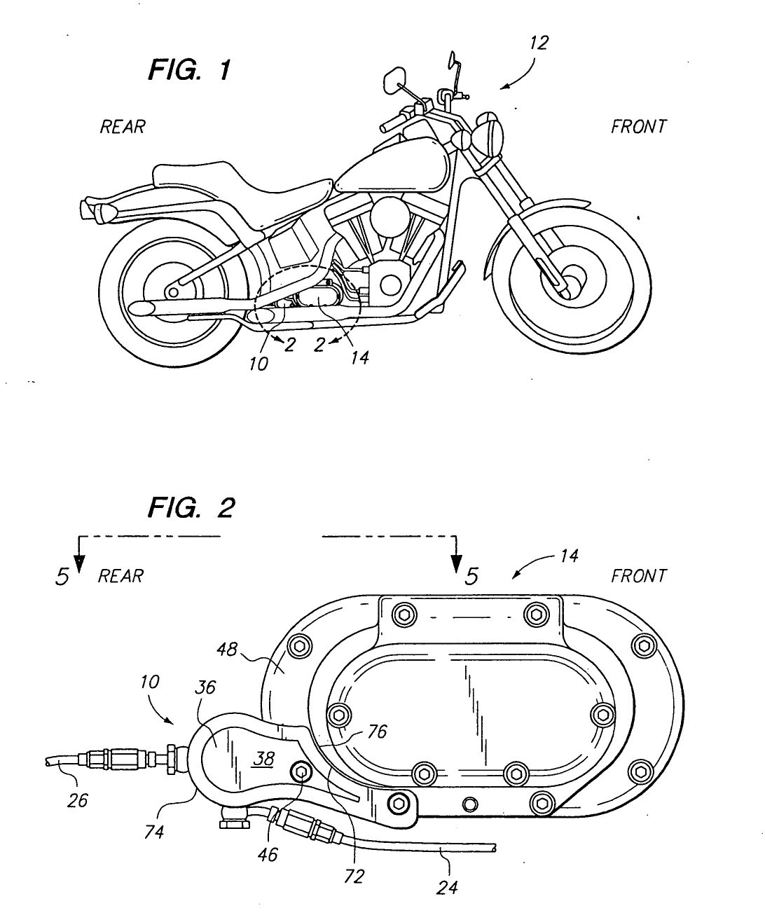

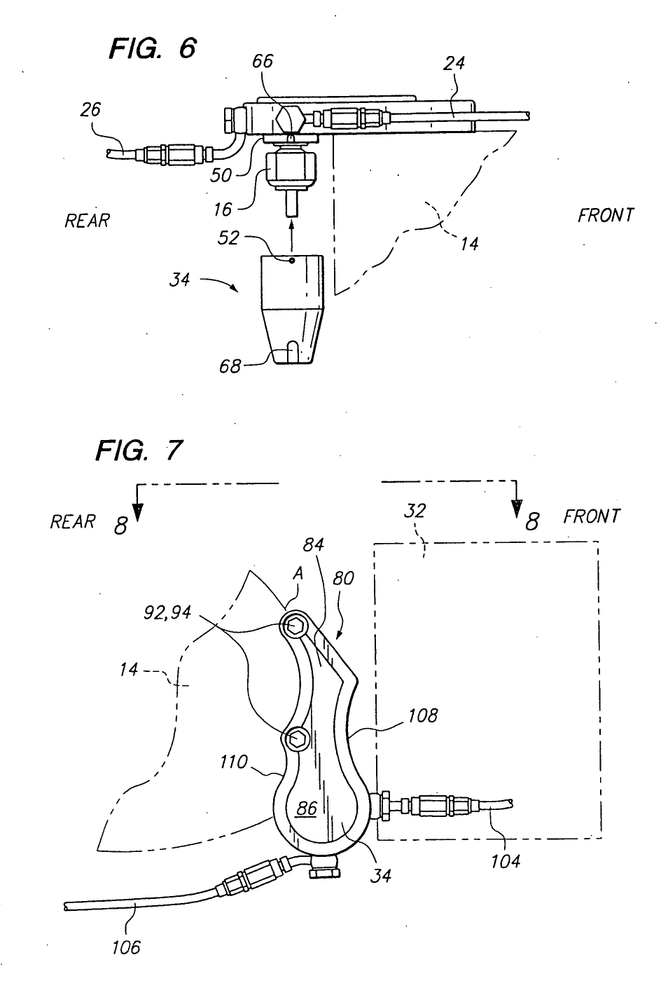

Referring now to the drawings which are for the purposes of illustrating a brake connector 10 and not for the purpose of limiting the brake connector 10 to the specific structure shown and described herein, FIG. 1 illustrates a perspective view of a motorcycle 12, specifically, a Harley Davidson motorcycle 12 with the brake connector 10 of a first embodiment attached to a transmission case 14 of the Harley Davidson motorcycle 12. The brake connector 10 is operative to protect a pressure sensor 16 (see FIGS. 5 and 6) which is used to activate a brake light 18 (see FIG. 4) when a brake pedal 20 (see FIG. 4) is depressed. In particular, the brake pedal 20 is operative to transfer brake fluid from a brake master cylinder 22 through an inlet fluid cable 24 to the brake connector 10 and through an outlet fluid cable 26 of the brake connector 10 to a rear caliper 28, as shown in FIGS. 2 and 4. The rear brake caliper 28 is operative to clamp brake pads on a rotor when the brake pedal 20 is depressed. As such when the brake pedal 20 is depressed, brake fluid from the brake master cylinder 22 is transferred from the brake master cylinder 22 through the inlet and outlet fluid cables 24, 26 to the rear brake caliper 28 to clamp brake pads on the rotor to stop or slow down the Harley Davidson motorcycle 12. Conversely, when the brake pedal 20 is released, brake fluid is urged back into the brake master cylinder 22 thereby the brake pads are released from the rotor allowing the Harley Davidson motorcycle 12 to accelerate.

For safe operation of the Harley Davidson motorcycle 12, the pressure sensor 16 may be attached to the brake connector 10 to sense an increased pressure in the inlet and outlet brake fluid cables 24, 26. For example, when the brake pedal 20 is depressed, the fluid within the inlet and outlet fluid cables 24, 26 is increased. The pressure sensor 16 senses the increased pressure and sends an electrical signal to an electrical system 30 (see FIG. 4) of the Harley Davidson motorcycle 12 which in turn activates the motorcycle's rear brake light 18 thereby indicating that the motorcycle 12 is slowing down or will stop.

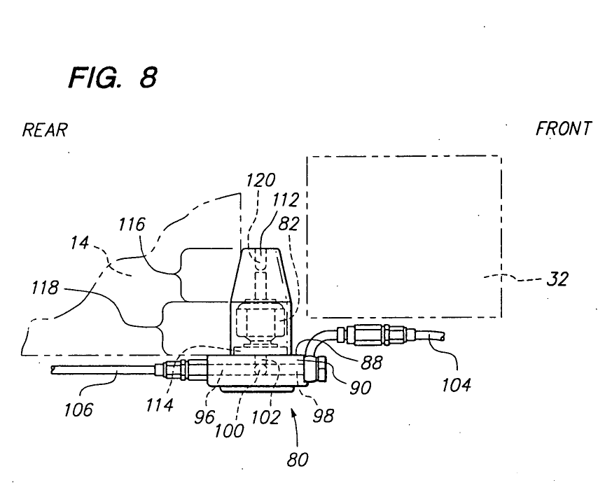

The pressure sensor 16 is protected from an environment because the pressure sensor 16 may be positioned behind the transmission case 14 for a left side drive Harley Davidson motorcycle 12 (see FIGS. 1-6) and between an engine 32 and the transmission case 14 for a right side drive Harley Davidson motorcycle 12 (see FIGS. 7 and 8). Also, a protective cover 34 covers the pressure sensor 16 such that road debris and the like projected toward the pressure sensor 16 does not damage the pressure sensor 16.

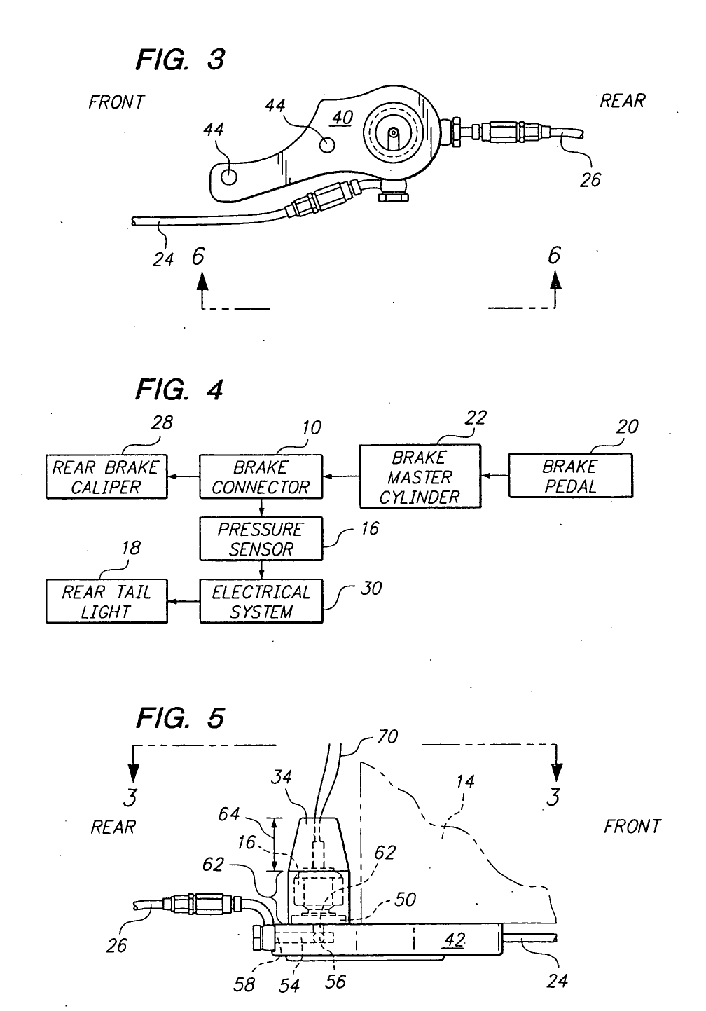

The brake connector 10 may comprise a main body 36 (see FIG. 2) defining front and rear surfaces 38, 40 (see FIGS. 2 and 3) as well as an outer peripheral surface 42 (see FIG. 5). The front surface 38 of the main body 36 may be exposed to the environment (e.g., road debris, projectiles and the like), whereas, the rear surface 40 may be protected from the environment by being positioned or directed toward a medial portion of the Harley Davidson motorcycle 12. The main body 36 may have at least one bolt hole 44 (see FIG. 4) which extends from the front surface 38 to the rear surface 40. The bolt hole 44 may be sized and configured to receive a bolt 46 (see FIG. 2) which may be bolted to a bolt hole of the transmission case 14 of the Harley Davidson motorcycle 12. Preferably, the main body 36 may have at least two bolt holes which extend from the front surface 38 to the rear surface 40 and are sized and configured to receive bolts 46 that may be bolted to two bolt holes of the transmission case 14. Moreover, the bolt holes 44 formed through the main body 36 may be spaced apart to match a bolt hole pattern of the transmission case 14. In this manner, additional holes do not need to be drilled and tapped into the transmission case 14 to mount the brake connector 10 to the transmission case 14 of the Harley Davidson motorcycle 12.

The rear surface 40 of the main body 36 may be sized and configured to receive a flange 48 (see FIG. 2) of the transmission case 14 of the Harley Davidson motorcycle 12. For example, the rear surface 40 may be flat or contoured as the situation may dictate. Moreover, the rear surface 40 of the main body 36 may extend beyond the flange 48 of the transmission case 14. More particularly, the rear surface 40 which extends past the flange 48 of the transmission case 14 may be sufficiently large for mounting the pressure sensor 16, as shown in FIG. 5. The rear surface 40 may also have a lip 50 (see FIGS. 5 and 6) which protrudes outward from the rear surface 40. The lip 50 may provide a surface for attaching the protective cover 34 to the lip 50 via a set screw 52 (see FIG. 6).

The outer peripheral surface 42 of the main body 36 may define an interface surface 72 and a contoured surface 74, as shown in FIG. 2. The interface surface 72 may be sized and configured to match an outer periphery 76 of the transmission case 14. By way of example and not limitation, the transmission case 14 may have a rounded convex outer periphery 76, and the interface surface 72 may have a matching rounded concave configuration. Moreover, a distance between the interface surface 72 and the outer periphery 76 of the transmission case 14 may be equal along an entire length of the interface surface 72.

The contoured surface 74 may be sized and configured to follow the general motif of the Harley Davidson motorcycle 12, and more particularly, the transmission case 14 of the Harley Davidson motorcycle 12 to which the brake connector 10 is connected or attached. By way of example and not limitation, the contoured surface 74 may have a curvilinear configuration. For example, as shown in FIG. 2, the contoured surface 74 may have an upper surface and a lower surface. The upper surface may be generally level with the ground and curved downward toward its rearward end. At the rearward end, the lower surface may curve back toward the transmission case 14. To further integrate the brake connector 10 with the general motif of the Harley Davidson motorcycle 12, the front surface 38, rear surface 40 and the outer peripheral surface 42 may be chromed. Preferably, the outer surfaces of the brake connector 10 is chromed.

Referring now to FIG. 5, the brake connector 10 may have a fluid conduit 54 formed therethrough. The fluid conduit 54 may have an inlet aperture 56, an outlet aperture 58 and a pressure sensor aperture 60. The inlet aperture 56 may be in fluid communication with the inlet fluid cable 24. The inlet fluid cable 24 is also in fluid communication with the brake master cylinder 22. The outlet aperture 58 is in fluid communication with the outlet fluid cable 26. Also, the outlet fluid cable 26 is in fluid communication with the rear brake caliper 28. The pressure sensor aperture 60 may be connected to the pressure sensor 16 for determining a pressure within the inlet and outlet fluid cables 24, 26, and more particularly, the fluid conduit 54. The pressure sensor 16 may be threadably engaged to the pressure sensor aperture 60 via internal threads of the pressure sensor aperture 60 and mating external threads of the pressure sensor 16. Depression of the brake pedal 20 transfers fluid from the brake master cylinder 22 through the inlet and outlet cables 24, 26 and fluid conduit 54 of the brake connector 10 to the rear brake caliper 28 thereby activating the rear brakes of the Harley Davidson motorcycle 12. Simultaneously, the pressure sensor 16 senses an increased pressure in the fluid conduit 54 indicating that the rear brake is being activated. The pressure sensor 16 sends an electrical signal to the electrical system 30 of the Harley Davidson motorcycle 12 which in turn activates the rear tail light 18 to indicate to nearby pedestrians, drivers, motorcyclists, etc. that the motorcycle 12 is slowing down or will stop.

FIG. 5 illustrates a top view of the motorcycle 12 shown in FIG. 1 and shows that a pressure sensor 16 is protected from an environment. In particular, when the motorcycle 12 is traveling forward, the transmission case 14 blocks projectiles and road debris from hitting the pressure sensor 16. Also, the pressure sensor 16 is also protected from the environment with the protective cover 34. In particular, the pressure sensor 16 may protrude from the rear surface 40 into a medial portion of the Harley Davidson motorcycle 12. The protective cover 34 may define a lower portion 62 and an upper portion 64. The lower portion 62 may have a cylindrical configuration, whereas, the upper portion 64 may have a frustal-conical configuration. The lower portion 62 may have an opening which is sized and configured to receive the pressure sensor 16. Also, the opening of the lower portion 62 may be sized and configured to match the outer periphery of the lip 50. In this manner, when the protective cover 34 is disposed over the pressure sensor 16 to protect the pressure sensor 16 from the environment, the opening of the lower portion 62 surrounds the lip 50. The set screw 52 may be threadably engaged to the lower portion 62 of the protective cover 34 and tightened onto the lip 50 to hold the protective cover 34 on the main body 36. Preferably, the lip 50 may have a depression 66 (see FIG. 6) sized and configured to receive the distal tip of the set screw 52. In this manner, the user may tighten the set screw 52 into the depression 66.

The upper portion 64 of the protective cover 34 may also have an opening or aperture 68 for the electrical wires 70 of the pressure sensor 16. The opening 68 provides a pathway for the electrical wires 70 of the pressure sensor 16 between the pressure sensor 16 and the electrical system 30 of the Harley Davidson motorcycle 12. The aperture 68 may begin from a center of the upper portion 64. The aperture 68 may have a slotted configuration which extends from the center to a side of the frustal-conical surface. When the brake connector 10 is mounted to the transmission case 14, the pressure sensor 16 wires may be fed through the aperture 68 of the upper portion 64 and connected to the electrical system 30 of the Harley Davidson motorcycle 12. The aperture of the lower portion 62 may be positioned about the lip 50 and the set screw 52 tightened on the lip 50 to hold the protective cover 34 on the main body 36. The aperture 68 of the upper portion 64 may be aligned to the set screw 52 (see FIG. 6). The depression 66 formed on the lip 50 may be oriented downward such that rain water is less likely to contact the pressure sensor 16 when the protective cover 34 is attached to the main body 36.

In a second embodiment of the brake connector 80, the same may be connected to a right side drive Harley Davidson motorcycle 12, as shown in FIGS. 7 and 8. In this instance, the brake connector 80 may be connected to a forward side of the transmission case 14 of the motorcycle 12 between the engine 32 and the transmission case 14. This embodiment of the brake connector 80 sandwiches the pressure sensor 82 between the transmission case 14 and the engine 32.

Similar to the first embodiment of the brake connector 80, the second embodiment of the brake connector 80 shown in FIGS. 7 and 8 may also have a main body 84 which defines a front surface 86, a rear surface 88 and an outer peripheral surface 90. The front surface 86 of the main body 84 may be exposed to projectiles, road debris, etc. when the brake connector 80 is attached to the transmission case 14 of the Harley Davidson motorcycle 12. The rear surface 88 may be directed toward the medial portion of the motorcycle 12 when the brake connector 80 is attached to the transmission case 14 of the Harley Davidson motorcycle 12.

Moreover, the main body 84 may have one, but preferably at least two bolt holes 92 which provides a means for bolting the brake connector 80 to the Harley Davidson motorcycle 12. In particular, the bolt holes 92 form apertures through the main body 84 from the front surface 86 to the rear surface 88 of the main body 84. The bolt holes 92 may be spaced apart from each other so as to match a bolt pattern of the transmission case 14 of the Harley Davidson motorcycle 12. In this manner, the brake connector 80 may be bolted directly onto the transmission case 14 of the Harley Davidson motorcycle 12 via bolts 94.

The main body 84 may also have a fluid conduit 96 (see FIG. 8) defining an inlet aperture 98, an outlet aperture 100 and a pressure sensor aperture 102. The inlet aperture 98 may be in fluid communication with the brake master cylinder 22 via an inlet fluid cable 104. The outlet aperture 100 may be in fluid communication with a rear caliper 28 via an outlet fluid cable 106. The pressure sensor aperture 102 may be connected to the pressure sensor 82 for determining a pressure within the fluid conduit 96. For example, the pressure sensor aperture 102 may have internal threads and the pressure sensor 82 may have mating external threads engageable to the internal threads of the pressure sensor aperture 102. Brake fluid in the brake master cylinder 22 and inlet fluid cable 104 may be transferred to the outlet fluid cable 106 and rear caliper 28 via the fluid conduit 96 of the brake connector 80. For example, when a rider depresses a brake pedal 20, brake fluid from the brake master cylinder 22 is transferred to the rear calipers 28 activating the rear brake and slowing down or stopping the Harley Davidson motorcycle 12. Conversely, when the rider releases the brake pedal 20, brake fluid is transferred from the rear caliper 28 to the brake master cylinder 22 allowing the motorcycle 12 to accelerate.

The outer peripheral surface 90 may define a contoured surface 108 and an interface surface 110. The contoured surface 108 may be sized and configured to follow the general motif of the Harley Davidson motorcycle 12. The contoured surface 108 may have a right hand side surface and a bottom surface may have a curvilinear configuration. In particular, the right hand side surface may generally extend tangentially from an outer periphery 76 of the transmission case 14 at point “A.” The right hand side surface continues downwardly in a smooth S shaped configuration. The bottom surface may have a bulbous configuration. The interface surface 110 may closely follow the contour of the outer periphery 76 of the transmission case 14. The distance between the interface surface 110 and the transmission case 14 may be consistent throughout the entire length of the interface surface 110.

The inlet aperture 98 of the main body 84 may be formed at the right hand side surface. Also, the outlet aperture 100 of the main body 84 may be formed at the bottom surface. The pressure sensor aperture 102 may be formed at the rear surface 88. The fluid conduit 96 may be formed in the main body 84 which connects the inlet aperture 98, the outlet aperture 100 and the pressure sensor aperture 102.

The pressure sensor 82 for the rear brake light 18 is protected from the environment by being interposed between the engine 32 and the transmission case 14. The pressure sensor 82 is also protected from the environment via a protective cover 112 which shields the pressure sensor 82. In particular, the rear surface 88 of the main body 84 may have a nub or lip 114. The nub or lip 114 may protrude out of the rear surface 88. The pressure sensor aperture 102 may be formed on the rear surface 88 at the nub or lip 114 and have internal threads. The pressure sensor 82 may be attached to the brake connector 80 via external threads of the pressure sensor 82 that mates with the internal threads of the pressure sensor aperture 102. The cover 112 may have a frusto conical top portion 116 and a cylindrical bottom portion 118 which collectively defines a cavity for receiving the pressure sensor 82. The cylindrical bottom portion 118 may have an aperture. The aperture of the cylindrical bottom portion 118 may be sized and configured to receive the pressure sensor 82. Also, such aperture may be sized and configured to mate over the nub or lip 114. The nub 114 may have a depression 66 which is sized and configured to receive a set screw 52 threadably engaged to the cylindrical bottom portion 118 of the cover 112 similar to the first embodiment. The frusto conical top portion 116 may have a slotted aperture 120. The slotted aperture 120 may begin from a center of the frusto conical top portion 116 and extend toward the set screw 52. The slotted aperture 120 provides a pathway for electrical wires 70 of the pressure sensor 82 to be routed to the electrical system 30 of the Harley Davidson motorcycle 12 similar to the first embodiment. The depression 66 formed in the nub or lip 50 may be oriented downwardly such that the slotted aperture 120 may also be oriented downwardly when the protective cover 112 is attached to the main body 84 such that rain water is less likely to contact the pressure sensor 82.

To mount the brake connector 10, 80 of the first and second embodiment, two bolts of the transmission case 14 may be removed from the transmission case 14. The pressure sensor 16, 82 may be threadably engaged to the pressure sensor aperture 60, 102. The inlet fluid cable 24, 104 may be attached to the inlet aperture 56, 98. The outlet fluid cable 26, 106 may be attached to the outlet aperture 58, 100. The cover 34, 112 may be secured to the nub or lip 50, 114 by tightening the set screw 52. The electrical wires 70 of the pressure sensor 16, 82 may be routed through the slotted aperture 68, 120 of the frusto conical top portion 64, 116. The two bolt holes 44, 92 of the brake connector 10, 80 may be matched to two bolt holes of the transmission case 14. Two elongate bolts 46, 94 may be inserted through the bolt holes 44, 92 of the brake connector 10, 80 and tightened onto the transmission case bolt holes. The pressure sensor 16, 82 is disposed behind the transmission case 14 for left side drive Harley Davidson motorcycles 12 and disposed between the transmission case 14 and the engine 32 for right side drive Harley Davidson motorcycles 12 to protect the pressure sensor 16, 82 from road debris, rain and other destructive forces. Also, the cover 34, 112 disposed over the pressure sensor 16, 82 protects the pressure sensor 16, 82 from road debris, rain and the like.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. For example, the brake connector 10 may be employed into other types of motorcycles 12 such as BMW, Suzuki, etc. Thus, the scope of the claims is not to be limited by the illustrated embodiments.

What is claimed is:

1. A brake connector for a Harley Davidson motorcycle, the Harley Davidson motorcycle having a brake master cylinder, rear brake caliper, a transmission case, an engine and an electrical system, the connector comprising:
a. a main body defining front and rear surfaces, a mounting hole formed through the main body for mounting the brake connector to the transmission case of the Harley Davidson motorcycle, the rear surface contacting the transmission case when the brake connector is mounted thereto, the main body having a brake fluid inlet connectable to the brake master cylinder and a brake fluid outlet connectable to the rear brake caliper;
b. a pressure sensor attached to the main body and operative to sense pressure at the brake fluid inlet and outlet, the pressure sensor protruding out from the rear surface such that the pressure sensor is behind the transmission case for protecting the pressure sensor from an environment when the brake connector is mounted to the transmission case; and
c. a cover removably attachable to the rear surface of the main body, the cover being sized and configured to receive pressure sensor for protecting the pressure sensor from the environment, the cover having a wiring aperture for routing electrical wires of the pressure sensor to the electrical system.

2. The brake connector of claim 1 further comprising at least one bolt insertable through the mounting hole from the front surface to the rear surface for attaching the main body to the transmission case.

3. The brake connector of claim 1 wherein the main body has two mounting holes, and the connector further comprises two bolts insertable through the mounting holes for attaching the main body to the transmission case.

4. The brake connector of claim 1 wherein two mounting holes are formed in the main body and match a bolt pattern of the transmission case.

5. The brake connector of claim 1 wherein the rear surface of the main body has a nub and the cover is attachable to the nub.

6. The brake connector of claim 5 wherein the nub is a lip.

7. The brake connector of claim 5 wherein the nub has a depression sized and configured to receive a set screw threadably engaged to the cover.

8. The brake connector of claim 1 wherein the cover is attachable to the nub via a set screw.

9. The brake connector of claim 1 wherein the cover has a frusto conical configuration.

10. The brake connector of claim 1 wherein the front surface and outer peripheral surface is chromed for following the general motif of a Harley Davidson motorcycle.

11. The brake connector of claim 1 wherein the brake connector is for a Harley Davidson motorcycle.

12. A brake connector for a Harley Davidson motorcycle, the Harley Davidson motorcycle having a brake master cylinder, rear brake caliper, a transmission case, an engine and an electrical system, the connector comprising:
a. a main body defining front and rear surfaces, a mounting hole formed through the main body for mounting the brake connector to the transmission case of the Harley Davidson motorcycle, the rear surface contacting the transmission case when the brake connector is mounted thereto, the main body having a brake fluid inlet connectable to the brake master cylinder and a brake fluid outlet connectable to the rear brake caliper;
b. a pressure sensor attached to the main body and operative to sense pressure at the brake fluid inlet and outlet, the pressure sensor protruding out from the rear surface such that the pressure sensor is interposed between the engine and the transmission case for protecting the pressure sensor from an environment when the brake connector is mounted to the transmission case; and
c. a cover removably attachable to the rear surface of the main body, the cover being sized and configured to receive pressure sensor for protecting the pressure sensor from the environment, the cover having a wiring aperture for routing electrical wires of the pressure sensor to the electrical system.

13. The brake connector of claim 12 wherein the brake connector is for a Harley Davidson motorcycle.
